(19) United States
(12) Patent Application Publication
(10) Pub. No.: US 2009/0210907 A1
(43) Pub. Date: Aug. 20, 2009

(54) METHOD AND SYSTEM FOR RECOMMENDING MULTIMEDIA CONTENT

(75) Inventors: Joshua J. Fox, Austin, TX (US); James Austin Britt, Manor, TX (US); Adam Klein, Cedar Park, TX (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/031,511

(22) Filed: Feb. 14, 2008

(51) Int. Cl. H04N 7/173

(52) U.S. Cl. 725/46

(57) ABSTRACT

A system and method are disclosed for providing recommendations of multimedia programs broadcast over a provider network using contact lists. For IPTV broadcast programs, recommendations by users may be for pay-per-view or on-demand programs. Upon ordering a multimedia program, a user may select from a contact list one or more other users for receiving a recommendation. Users receiving recommendations may configure a receiving filter to block or allow recommendations based on the identity of the sending user, a time period, the number or type of multimedia programs recommended, or other criteria.

### BACKGROUND

1. Field of the Disclosure

The present disclosure generally relates to providing multimedia content, and more specifically, to recommending multimedia content.

2. Description of the Related Art

Multimedia content in the form of video-on-demand movies or scheduled pay-per-view events may be ordered by a consumer for viewing via a provider network. Providing a recommendation for multimedia content to a consumer often involves collecting information about the consumer, such as previous viewing habits or purchasing activity, in an attempt to make a meaningful recommendation

### BRIEF DESCRIPTION OF THE DRAWINGS

FIG. 1 illustrates selected elements of a representative Internet Protocol Television (IPTV) system for implementing disclosed embodiments of a multimedia content recommendation system;

FIG. 2 illustrates selected elements of an embodiment of a multimedia content recommendation method; and

FIG. 3 illustrates selected elements of a data processing system suitable for performing the multimedia content recommendation method of FIG. 2.

### DESCRIPTION OF THE EMBODIMENT(S)

In one aspect, a method is disclosed for recommending a multimedia program by a first user of a provider network. The method comprises enabling selection of the multimedia program for receiving over the provider network, wherein the provider network delivers Internet protocol (IP) based broadcasting. The method further comprises enabling selection of a second user of the provider network from a contact list, wherein the contact list is associated with the first user; and sending an indication to the second user that the multimedia program has been recommended by the first user. Presence information for the second user may be used for sending the indication to the second user. In some embodiments, the method further comprises enabling the second user to allow recommendations for multimedia programs to be received from the first user; and receiving the indication from the first user that the multimedia program has been recommended. In certain embodiments, the method further comprises enabling the second user to prohibit recommendations for multimedia programs to be received from the first user, and rejecting the indication from the first user that the multimedia program has been recommended. The multimedia program may be an IP based television broadcast; and the multimedia program may be delivered on a pay-per-view basis. The multimedia program may be an IP based television broadcast; and the multimedia program may be delivered on an on-demand basis. The multimedia may include an audio broadcast. The multimedia may also include a video broadcast. The contact list may be accessible by the first user via the provider network; and the contact list may include presence information for the second user. In some embodiments, the first user selects the multimedia program for recommending to the second user. The first user selects the second user from the contact list and uses a set-top box enabled for bidirectional-communication with the provider network to select the multimedia program and the second user. In further embodiments, the first user selects the multimedia program for recommending to the second user. The first user selects the second user from the contact list and uses a wireless communications device to select the multimedia program and the second user. In still further embodiments, the first user selects the multimedia program for recommending to the second user. The first user selects the second user from the contact list and uses the Internet to select the multimedia program and the second user.

In another aspect, a computer program product stored on a computer readable medium includes computer executable instructions for recommending a first multimedia program by a first user of a provider network. Further instructions are executable to enable the first user to select the first multimedia program for viewing over a provider network, wherein the provider network broadcasts a plurality of IP based television programs. Instructions are further executable to enable the first user to select a first plurality of users of the provider network from a contact list, wherein the contact list is associated with the first user and the first plurality of users does not include the first user. Further instructions are executable to send an indication to the first plurality of users that the first multimedia program has been recommended by the first user. The program instructions may be further executable to enable a second user to allow recommendations for multimedia programs to be received from the first user, wherein the second user is included in the first plurality of users, and to receive the indication from the first user that the first multimedia program has been recommended to the second user. The program instructions may be further executable to enable the second user to automatically record the first multimedia program on a digital video recorder (DVR). The program instructions may be further executable to receive the indication from the first user that the first multimedia program has been recommended to the first plurality of users. The program instructions may be still further executable to enable the second user to purchase the first multimedia program for viewing over the provider network. The program instructions may be further executable to enable a third user to prohibit recommendations for multimedia programs to be received from the first user, wherein the third user is included in the first plurality of users, and to reject the indication from the first user that the first multimedia program has been recommended to the third user. The program instructions may also be further executable to enable a fourth user to determine when recommendations for multimedia programs are allowed to be received from the first user, wherein the fourth user is included in the first plurality of users. The program instructions may be further executable to enable a fifth user to determine how many recommendations for multimedia programs are allowed to be received from the first user, wherein the fifth user is included in the first plurality of users. The program instructions may be yet further executable to enable the first user to select a second multimedia program for viewing over the provider network, wherein the first user uses a wireless communication device; enable the first user to select a second plurality of users of the provider network from the contact list, wherein the second plurality of users is different from the first plurality of users, wherein the second plurality of users does not include the first user; and to send an indication to the second plurality of users that the second multimedia program has been recommended by the first user.

In an additional aspect, a system for recommending a multimedia program purchased by a first user of a provider network, comprising a processor and a memory, including program instructions executable by the processor is disclosed. The program instructions are executable to enable the first user to purchase the multimedia program for viewing over a provider network, wherein the provider network broadcasts a plurality of IP based television programs. The program instructions are further executable to enable the first user to select a first plurality of users of the provider network from a contact list, wherein the contact list is accessible by the first user via the provider network; and send an indication over the provider network to the first plurality of users that the multimedia program has been recommended by the first user, wherein presence information for the first plurality of users is stored in the contact list. Presence information for the first plurality of users may be used for sending the indication to the first plurality of users. At least some of the first plurality of users may be present on the provider network using a set-top box. At least some of the first plurality of users may be present on the provider network using a wireless communications device. The program instructions may be further executable to send the indication over the provider network to the first plurality of users using a text message.

In yet an additional aspect, a service for recommending a multimedia program by a first user of a provider network is disclosed. The service comprises provisioning a server to receive a request from the first user to recommend the multimedia program to a second user of the provider network, wherein the second user is included in a contact list associated with the first user, wherein the contact list is maintained by the server, wherein the contact list includes presence information for the second user. The service further comprises enabling a set-top box associated with the second user to receive the recommendation from the first user; and enabling the second user to purchase the multimedia content. In some embodiments, the service further comprises, based on the presence information for the second user, enabling a wireless device associated with the second user to receive the recommendation from the first user.

In the following description, for the purposes of explanation, numerous specific details are set forth in order to provide a thorough understanding of the disclosed embodiments. A person of ordinary skill in the art should recognize that embodiments may be practiced without some of these specific details. In other instances, well-known structures and devices may be shown in block diagram form or omitted for clarity.

Television programs, movies, radio programming and other multimedia content may be distributed over a “provider network,” which may include telephone company networks, coaxial-based networks, Ethernet networks, satellite transmissions, WiFi transmission, WiMAX transmission, and the like. In some systems, for example traditional coaxial-based “cable” systems, a service provider may distribute through the same coaxial or fiber-optic cable a compound signal containing a number of television channels at different frequencies. In conjunction, a set-top box or a tuner within a television, radio, or recorder selects one or more channels from the compound signal to play or record. In contrast to such systems that simultaneously distribute every available channel at all times, IPTV systems generally distribute content only in response to user requests. As used herein, a “user” (also referred to as a “consumer” or a “customer”) refers to a terminal recipient of multimedia content provided by the provider network. A user may operate a network device, or other equipment, to select and receive the multimedia content over the provider network.

IPTV systems typically use IP and other technologies found in computer networks. To provide IPTV, a user's telephone lines or a fiber connection may be used in some combination with a residential gateway (RG), a digital subscriber line (DSL) modem, a set-top box (STB), a display, and other such equipment to receive and convert into usable form the multimedia content provided from a telephone company network, for example.

IPTV providers, satellite-based providers, digital cable providers, and others may distribute multimedia content using bidirectional (i.e., two-way) communication between a user's customer premises equipment (CPE) and the service provider's equipment. In some embodiments, multimedia content is provided directly to a user's wireless communications device using IPTV, for example, streaming video and audio. Bidirectional communication allows a service provider to offer advanced features, such as video-on-demand (VOD), pay-per-view, advanced programming information, text-based news, applications, and the like.

The methods and systems disclosed herein provide embodiments for recommending multimedia content. In one embodiment, a user may select an IPTV program for recommending upon ordering the IPTV program for viewing or recording. The user may use a STB, an instant messaging client, a wireless communication device, an email client, a personal computer (PC), or a combination thereof, to order to recommend the IPTV program. The user can select one or more recipients from a contact list for the recommendation. The recipients for the recommendation may also be users of the provider network, and therefore, may also be able to order the recommended IPTV program.

As used herein, a “contact list” refers to a list of contact information for individual persons, such as an address book, or a telephone directory. In some embodiments, a contact list includes contact information for several communication channels, such as telephone numbers, fax numbers, email addresses, instant messaging addresses, wireless telephone numbers, network addresses, STB location, etc. The contact list may also provide presence information for individual persons based on their available contact information. For example, a contact list may be stored and maintained by the provider network, which can query a STB location to determine if an individual listed in the contact list (who is also a user of the provider network) is currently logged in to the STB or that the STB is in use. In this manner, recommendations may be transmitted via the provider network between users using different contact lists associated with each user. In one embodiment, access to the same contact list, managed centrally by a server coupled to the contact network, is provided to a user regardless of the communication channel used to access the provider network, such as a STB, a wireless communication device, an Internet-browser on a PC, or an instant messaging client.

Therefore, in some embodiments, the user is provided with parallel communication options with the provider, such as functions on a STB, instant messaging, an Internet website, or a voice-based interface, to initiate the recommendation. The provider may use any combination of communication means to send multimedia output to the user, or to receive multimedia input from the user. The disclosed embodiments are configurable to send the recommendation of the IPTV program (or other multimedia content) in the form of a multimedia output, such as a text message, email, audio message, voice message, or a graphical user interface (GUI) display to the selected one or more recipients.

Accordingly, a user of the provider network may be an initiator or a recipient (or both) of recommendations for IPTV programs broadcast over the provider network. As a recipient of recommendations, a user may establish a receiving filter to prohibit or allow certain recommendations. For example, recommendations from a certain individual, based on contact information in the contact list, may be prohibited (i.e., blocked). Additionally, recommendations from unknown contacts can be blocked. The blocking filter of received recommendations may further be limited for a certain time period, or to a certain number of recommendations. For example, a first user sending recommendations may be allowed by a second, receiving user to send the second user 10 recommendations per week.

The receiving filter may also include the designation of “trusted users,” whose recommendations may carry additional weight or importance. In some embodiments, a recommendation from a trusted user results in an emphasis of the received recommendation, such as an audio alarm, boldface, priority to the top of a list of recommendations, automatic recordings scheduled, etc. In one embodiment, recommendations received from a first user may be automatically ordered by a second user by configuring the receiving filter accordingly.

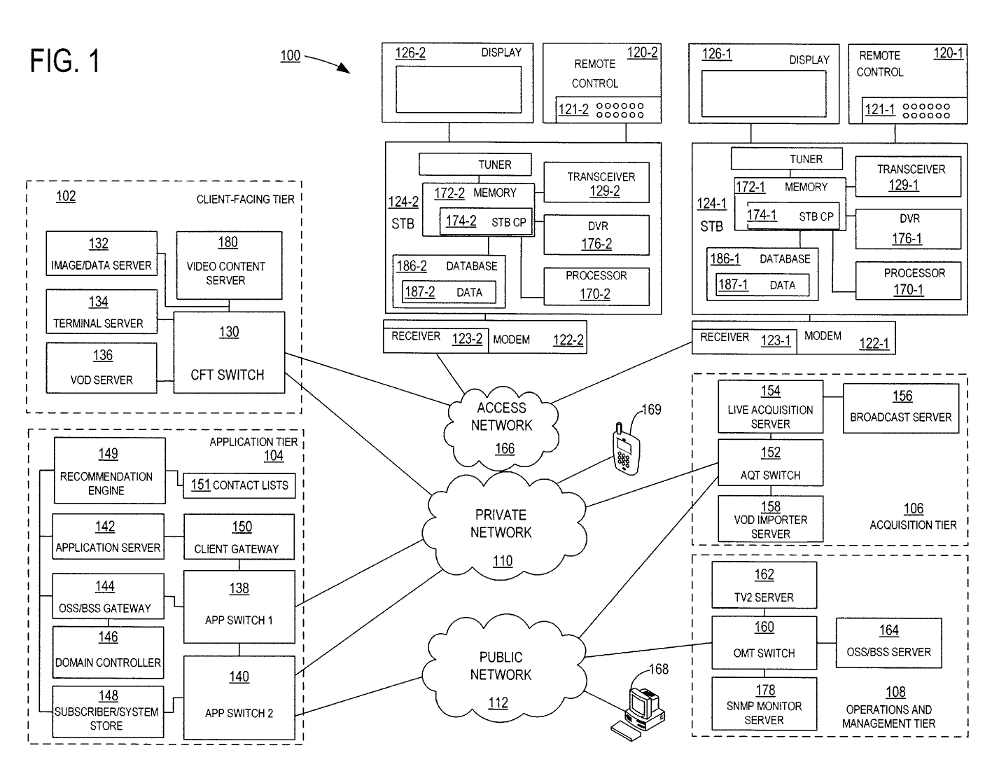

Referring now to the drawings, FIG. 1 illustrates selected aspects of an IPTV system 100 operated as part of a service provider network. Throughout this disclosure, a hyphenated form of a reference numeral refers to a specific instance of an element and the un-hyphenated form of the reference numeral refers to the element generically or collectively. Thus, for example, reference numeral 124-1 refers to an instance of an element 124. As shown in FIG. 1, IPTV system 100 includes two STBs 124 including STB 124-1 and STB 124-2. In the depicted embodiment, STBs 124 communicate through access network 166 via modems 122 (i.e., modem 122-1 and modem 122-2).

As shown, IPTV system 100 is configured to provide multimedia content to users of STBs 124 and includes a client facing tier 102, an application tier 104, an acquisition tier 106, and an operations and management tier 108. Tiers 102, 104, 106 and 108 are coupled to a private network 110, to a public network 112 (e.g., the Internet), or to both the private network 110 and the public network 112. Any of the various tiers coupled to the various networks may communicate with one another over the networks. For example, as shown, the client-facing tier 102 may communicate through the private network 110 with the acquisition tier 106. Further, as shown, the application tier 104 may communicate through the private network 110 and the public network 112 with the acquisition tier 106. The interconnections between illustrated tiers and networks in FIG. 1 are meant as instructive and not limiting.

As shown, IPTV system 100 distributes multimedia content to users of STBs 124 for viewing on displays 126 and possibly for sending to other components not shown, such as stereo equipment. In order to distribute the multimedia content, IPTV system 100 first gains access to the multimedia content. To that end, acquisition tier 106 represents a variety of systems to acquire multimedia content, reformat it when necessary, and prepare it for transmission over private network 110 or public network 112. In its capacity at acquiring and distributing multimedia for use on IPTV system 100, acquisition tier 106 serves as a “content headend.” Acquisition tier 106 may include, for example, systems for capturing analog and/or digital content feeds, either directly from a content provider or from a content aggregation facility. Content feeds transmitted via VHF/UHF broadcast signals may be captured by broadcast server 156. Similarly, live acquisition server 154 may capture satellite signals, high-speed fiber feeds, or programming feeds sent over other suitable transmission means. Content feeds to live acquisition server 154 may include broadcasted multimedia content, for example premium audio/video programming (i.e., traditional “cable channels”) widely available but not typically broadcast over airwaves. Acquisition tier 106 may further include signal conditioning systems and content preparation systems for encoding content. As shown, acquisition tier 106 includes VOD importer server 158 and may include a digital rights management (DRM) server for encrypting content (not shown). VOD importer server 158 receives content from one or more VOD sources that may be outside the IPTV system 100, for example discs or transmitted feeds. VOD importer server 158 may temporarily store multimedia content for transmission to a VOD server 136 on client-facing tier 102. In addition, the VOD content may be stored at one or more servers, such as the VOD server 136. The stored VOD content may be distributed by multicast (i.e., a single stream sent simultaneously to multiple viewers) or by unicast to individual users in a VOD system.

After acquiring the multimedia content, IPTV system 100 distributes the content over private network 110, for example. Private network 110 may be referred to as a “core network.” In some embodiments, private network 110 consists of a fiber backbone (i.e., wide area network (WAN)) and one or more video hub offices (VHOs). Generally, private network 110 transports multimedia content (e.g., video, music, Web pages, channel lineups, and data) from the acquisition tier 106 to STBs 124 through access network 166 (via client-facing tier (CFT) switch 130). In this role, private network 110 serves as the “backbone” for IPTV system 100. In a large deployment of IPTV system 100 that covers a vast geographic region, private network 110 may represent several smaller networks that may only transfer content within a subset of the region. Accordingly, private network 110 may provide for the insertion of local content that is relevant only to a subset region. For example, private network 110 may allow for the localized insertion of local advertisements or local emergency alert systems for a particular service area.

To illustrate the distribution of multimedia content acquired by acquisition tier 106, in an example embodiment, broadcast server 156 acquires broadcast multimedia content and communicates it to live acquisition server 154. Live acquisition server 154 transmits the multimedia content to the AQT (AcQuisition Tier) switch 152. In turn, the AQT switch 152 transmits the multimedia content to the CFT switch 130, for example, via the private network 110. As shown, the CFT switch 130 may communicate the multimedia content through modems 122 via the access network 166. In some embodiments, STBs 124 receive the multimedia content via modems 122 and transmit it to displays 126.

In some embodiments, live acquisition server 154 and VOD importer server 158 take numerous data streams and encode them into a digital video format, such as MPEG-2, or MPEG-4. After encoding, data streams may be encapsulated into IP data streams and transmitted to specific IP destinations (e.g., STBs 124) in response to a user's request for a particular channel, for example. Video content server 180, VOD server 136, or image/data server 132 may act as an intermediary or repository for multimedia content obtained and encoded by acquisition tier 106. In some embodiments, multimedia content is transmitted to the video content server 180, where it is encoded, formatted, stored, or otherwise manipulated and prepared for communication to the STB 124.

As shown, IPTV system 100 includes access network 166. Access network 166 provides a network link from the private network 110 to the consumer's location. To this end, access network 166 provides a network translation as necessary from a switched network, for example, to the access technology used to transmit data and multimedia content to the consumer's location. For example, a service provider that uses twisted-pair telephone lines to deliver multimedia content to consumers may utilize DSL within access network 166. The DSL may utilize some combination of DSL, DSL2, DSL2+, ADSL, VDSL or other technologies. In some embodiments, access network 166 may use fiber-to-the-home (FTTH). In such cases, optical fiber may be used all the way to the consumer's location to easily provide high-bandwidth. In other embodiments, fiber-to-the-curb (FTTC) deployments are used to deliver multimedia content to consumers. In such cases, a DSL access multiplexer (DSLAM) may be used within access network 166 to transfer signals containing multimedia content from optical fiber to copper wire for DSL delivery to consumers. In other embodiments, access network 166 may use radio frequency (RF) signals sent over coaxial cables. Accordingly, access network 166 may utilize quadrature amplitude modulation (QAM) equipment for downstream traffic. In these systems, access network 166 may receive upstream traffic from a consumer's location using quadrature phase shift keying (QPSK) modulated RF signals. In such systems, a cable modem termination system (CMTS) may be used to mediate between IP-based traffic on private network 110 and access network 166.

In operation, if a user requests VOD content via an STB 124, the request may be transmitted over the access network 166 to VOD server 136, via the CFT switch 130. Upon receiving the request, the VOD server 136 retrieves or accesses the requested VOD content and transmits the content to the STB 124 across access network 166 via CFT switch 130. In turn, STB 124 transmits relevant video portions of the VOD content to the display 126. STB 124 may transmit audio portions of the VOD content to a stereo system (not shown) or may allow (or disallow) sending the VOD content to a recording device (not shown).

As shown, IPTV system 100 includes application tier 104. Application tier 104 communicates with acquisition tier 106 and client-facing tier 102 through private network 110. Application tier 104 may communicate through various communication protocols including hypertext transfer protocol (HTTP). Generally, application tier 104 may include notification servers, billing servers, and any of a variety of subscriber application servers employed by an owner or operator (i.e., network service provider) of IPTV system 100. In some embodiments, elements of the application tier 104 such as client gateway 150 communicate directly with the client-facing tier 102. The components of client-facing tier 102 may communicate using HTTP, transmission control protocol (TCP) or datagram protocol (UDP), as examples.

As illustrated in FIG. 1, the client-facing tier 102 is coupled for communication with user equipment (e.g., modems 122) via access network 166. Access network 166 may be referred to as the “last mile” for a service provider or network operator. It provides network connectivity of IPTV services to consumers' locations. Client-facing tier 102 may multicast multimedia content to multiple destinations. For example, the same multimedia content may be distributed substantially simultaneously to STB 124-1 and STB 124-2. In contrast to a multicast or a unicast, some embodiments “broadcast” programming or data to all users on a network as a “broadcast” transmission. For example, a TV guide feature for displaying available programming may be broadcast to every user.

To deliver multimedia content, client-facing tier 102 may employ any current or future IPs for providing reliable real-time streaming multimedia content. In addition to the TCP, UDP, and HTTP protocols discussed above, such protocols may use, in various combinations, other protocols including, file transfer protocol (FTP), real-time transport protocol (RTP), real-time control protocol (RTCP), and real-time streaming protocol (RTSP), as examples. In some embodiments, client-facing tier 102 sends multimedia content encapsulated into IP packets over access network 166. For example, an MPEG-2 transport stream may be sent, in which the transport stream consists of a series of 188-byte transport packets, for example. To ensure quality of service, protocols should be chosen that minimize dropped packets, jitter, delay, data corruption, and other errors.

As shown, modems 122 include receivers 123 for receiving data. As shown, the client-facing tier 102 may communicate with a large number of STBs, such as representative STBs 124, over a wide area, which may be for example, a regional area, a metropolitan area, a viewing area, a designated market area, or any other suitable geographic area, market area, or user group supported by networking the client-facing tier 102 to numerous STBs. In an illustrative embodiment, the client-facing tier 102, or any portion thereof, may be included at a video headend office (not depicted).

In some embodiments, the client-facing tier 102 may be coupled to modems 122 via fiber optic cables. Alternatively, modems 122 may be DSL modems coupled to one or more network nodes via twisted pairs. STBs 124 may process data received over the access network 166 via various IPTV software platforms that are commonly known.

In an illustrative embodiment, the client-facing tier 102 includes a CFT switch 130 that manages communication between the client-facing tier 102 and the access network 166. CFT switch 130 also manages communication between the client-facing tier 102 and the private network 110 and is coupled to an image/data server 132 that may store streaming multimedia content and possibly still images associated with programs of various IPTV channels. Image/data server 132 stores data related to various channels, for example, types of data related to the channels and to programs or video content displayed via the channels. In an illustrative embodiment, image/data server 132 may be a cluster of servers, which may store streaming multimedia content, still images, channel and program-related data, or any combination thereof. CFT switch 130 may also be coupled to terminal server 134 that provides terminal devices with a connection point to the private network 110. As shown, CFT switch 130 may also be coupled to VOD server 136 that stores or provides VOD content imported by the IPTV system 100. As shown, the client-facing tier 102 also includes video content server 180 that transmits video content requested by viewers to STBs 124. In some embodiments, video content server 180 includes one or more multicast servers.

As illustrated in FIG. 1, application tier 104 may communicate with numerous components through private network 110 and public network 112. As shown, application tier 104 includes a first application tier (APP) switch 138 and a second APP switch 140. The first APP switch 138 is coupled to the second APP switch 140 and a combination operation-systems-support (OSS) and billing-systems-support (BSS) gateway 144 (i.e., OSS/BSS gateway 144). In some embodiments, the OSS/BSS gateway 144 controls access to an OSS/BSS server 164 that stores operations and billing systems data.

As shown, application tier 104 includes application server 142. Application server 142 may be any data processing system with associated software that provides information services (e.g., applications) for clients or consumers. Application server 142 may be optimized to provide services including conferencing, voicemail, and unified messaging. In some embodiments, services include electronic programming guides (EPG), conditional access systems (CAS), DRM servers, a navigation/middleware server, and IPTV portal, e-mail services, and remote diagnostics. As shown, application server 142 is associated with or communicates with recommendation engine 149 which, as will be described in detail below, is configured to recommend multimedia content using contact list 151 according to the methods described herein. Recommendation engine 149, as shown in FIG. 1, is also coupled to subscriber/system store 148 listed in contact list 151, which may be used in conjunction with contact list 151 to obtain information about the users listed in contact list 151. For example, subscriber/system store 148 may provide presence information about users listed in contact list 151, whereby the presence information may be used to select a communication path to a user in methods for providing recommendations herein, as described in further detail below.

As shown in FIG. 1, second APP switch 140 is communicatively coupled to a domain controller 146 that provides web access, for example, to users via the public network 112. The second APP switch 140 is communicatively coupled to a user and system store 148 that includes account information, such as account information that is associated with users who access the system 100 via the private network 110 or the public network 112. Therefore, for example, a user may employ a PC 168 to receive IPTV account information via the public network 112. Similarly, a user may employ cellular telephone 169 or another similar multifunction device over private network 110 or public network 112 to receive information through second APP switch 140. In some embodiments, application tier 104 may also include a client gateway 150 that communicates data directly with the client-facing tier 102. In these embodiments, the client gateway 150 may be coupled directly (not shown for clarity in FIG. 1) to the CFT switch 130. Accordingly, the client gateway 150 may provide user access to the private network 110 and the tiers coupled thereto.

In some embodiments, STB 124 accesses the IPTV system 100 via the access network 166, using information received from the client gateway 150. In such embodiments, access network 166 may provide security for the private network 110. Therefore, user devices may access the client gateway 150 via the access network 166, and the client gateway 150 may allow such devices to access the private network 110 once the devices are authenticated or verified. Similarly, the client gateway 150 may prevent unauthorized devices, such as hacker computers or stolen STBs, from accessing the private network 110, by denying access to these devices beyond the access network 166.

Accordingly, in some embodiments, when an STB 124 accesses the IPTV system 100 via the access network 166, the client gateway 150 verifies user information by communicating with the subscriber/system store 148 via the private network 110, the first APP switch 138, and the second APP switch 140. The client gateway 150 verifies billing information and user status by communicating with the OSS/BSS gateway 144 via the private network 110 and the first APP switch 138. The OSS/BSS gateway 144 may transmit a query across the first APP switch 138, to the second APP switch 140, and the second APP switch 140 may communicate the query across the public network 112 to the OSS/BSS server 164. Upon the client gateway 150 confirming user and/or billing information, the client gateway 150 allows the STBs 124 access to IPTV content, VOD content, and other services. If the client gateway 150 cannot verify user information for an STB 124, for example, because it is connected to an unauthorized twisted pair or RG, the client gateway 150 may block transmissions to and from that STB 124 beyond the access network 166.

The STBs 124 convert digital compressed signals into a format suitable for display. STBs 124 have functionality for recognizing and acting on IP packets such as UDP datagrams. STBs 124 may contain software or firmware coding for sending requests to application server 142, for example, to receive requested programming or data. In some embodiments, requests for content (e.g., VOD content) flow through a billing or management server to verify that a user is not in arrears regarding payment. In some embodiments, STBs 124 supports Web browsing on the Internet (e.g., public network 112) and may support cycling through guide data, for example, using Web services. STBs 124 may be enabled for viewing e-mail, viewing e-mail attachments, and interfacing with various types of home networks.

In accordance with disclosed embodiments, STBs 124 may be cable boxes, satellite boxes, or EPG boxes. Further, although shown separately, STBs 124 may be incorporated into any multifunctional device such as a television, a videocassette recorder, a DVR, a computer, a PC media player, or other media device. Generally, each STB 124 represents a dedicated data processing system (e.g., computer) that provides an interface between a display and a service provider. As shown, STBs 124 are connected to the service provider through modems 122. The modems shown in FIG. 1 are for illustrative purposes and are not meant to limit claimed subject matter from including other RGs. Alternatively, STBs 124 may be connected directly to access network 166 without external RGs.

STBs 124 contain software or firmware instructions stored in memories 172 or other storage for receiving and processing input from remote control units 120. In some embodiments, STBs 124 are IP based STBs and have capability for outputting resultant multimedia signals (e.g., streaming audio/video) in various formats including S-video, composite video, high definition component video, high definition multimedia interface (HTMI), and video graphics array (VGA) signals. The resultant multimedia signals may support displays 126 that have various video modes including analog National Television System Committee (NTSC), 1080i, 1080p, 480i, 480p, 720p, as examples. In some embodiments, STBs 124 communicate with modems 122 over local area networks (LANs) connected using CAT5 cables, CAT6 cables, wireless interfaces, or a Home Phoneline Networking Alliance (HPNA) network, as examples.

As shown STBs 124 are coupled to displays 126. Displays 126 may include a cathode ray tube (CRT), television, monitor, projected image, plasma screen, liquid crystal display (LCD) screen, holograph, or other graphical equipment.

STBs 124 may communicate with remote control units 120. STBs 124 may include wireless transceivers 129 to communicate with wireless transceivers (not shown) of remote control units 120. Mechanical buttons, slides, switches, or touch screens (with corresponding user interfaces) associated with remote control units 120 may be used to accept user input; such elements are collectively referred to herein as “buttons.” Alternatively, remote control units 120 may be used in conjunction with STBs 124 to operate GUIs displayed on displays 126.

STBs 124 as shown receive data 187, which may include video content and/or audio content or portions, from the client-facing tier 102 via the access network 166. Data 187 may be associated with at least one program, such as a broadcast program, that includes streaming multimedia content. As it receives data 187, STB 124 may store the content or may format the content into a resultant multimedia signal for sending to displays 126 and other equipment (not shown) for producing portions of the multimedia content in usable form (e.g., audio and video output).

As shown in FIG. 1, STBs 124 include processors 170 and memories 172 that are accessible by processors 170. Computer programs (STB CP) 174, as shown, are embedded within memories 172. As shown, memories 172 are coupled with databases 186 that include data 187. It is noted that individual instances of STBs 124, for example STB 124-1 and STB 124-2, may not be identically equipped in other embodiments (not shown). In certain embodiments, components, such as database 186-2, are omitted from individual STBs 124, such as STB 124-2. In some embodiments, computer program 174-1 is different from computer program 174-2, for example, by employing a different scope of user interface functionality.

In addition to or in conjunction with STB components illustrated in FIG. 1, STBs 124 may contain modules for transport, de-multiplexing, audio/video encoding and decoding, audio digital to analog converting, and RF modulation. For clarity, such details for these modules are not shown in FIG. 1. In addition, details are not provided for allowing STBs 124 to communicate with each other or other devices through access network 166. However, such communications can be carried out with known protocols and systems for network interfacing such as conventional network interface cards (NICs) used in PC platforms. For example STBs 124 may use a network interface that implements level 1 (physical) and level 2 (data link) layers of a standard communication protocol stack by enabling access to a twisted pair or other form of physical network medium and supporting low level addressing using media access control (MAC) addressing. In these embodiments, STBs 124 may have a network interface including a globally unique 48-bit MAC address stored in a read-only memory or other persistent storage element. Similarly, modems 122 (or other RGs) may have a network interface (not depicted) with their own globally unique MAC address. Further, although STBs 124 are depicted with various functions in separate components, these components may be implemented with a system on chip (SoC) device that integrates two or more components.

As shown, STBs 124 may also include a video content storage module, such as DVRs 176. In a particular embodiment, STBs 124 communicate commands received from the remote control units 120 to the client-facing tier 102 via the access network 166. Commands received from the remote control units 120 may be entered via buttons 121.

IPTV system 100 includes an operations and management tier 108 that has an operations and management tier (OMT) switch 160. OMT switch 160 conducts communication between the operations and management tier 108 and the public network 112. The OMT switch 160 is coupled to a TV2 server 162. Additionally, the OMT switch 160 as shown is coupled to an OSS/BSS server 164 and to a simple network management protocol (SNMP) monitor server 178 that monitors network devices within or coupled to the IPTV system 100. In some embodiments, the OMT switch 160 communicates with the AQT switch 152 via the public network 112.

In an illustrative embodiment, the live acquisition server 154 transmits the multimedia content to the AQT switch 152, and the AQT switch 152, in turn, transmits the multimedia content to the OMT switch 160 via the public network 112. In turn, the OMT switch 160 transmits the multimedia content to the TV2 server 162 for display to users accessing the user interface at the TV2 server 162. For example, a user may access the TV2 server 162 using a PC 168 coupled to the public network 112.

In some embodiments, the channels include broadcast channels sent over coaxial cables. The channels may also include broadband channels, for example high-speed, high-capacity data transmission channels that send and receive information on cable. The cable, which may be coaxial cable or fiber-optic cable, may have a wider bandwidth than conventional telephone lines, and may have the ability to carry video, voice, data, and other multimedia content simultaneously.

Embodiments disclosed herein use IPTV system 100 to process recommendations for viewing multimedia content. An order to receive an IPTV program (e.g., for viewing or recording) may be initiated by the user using a wireless communication device, such as cellular telephone 169 or remote control unit 120, or other device. Orders for IPTV programs may also originate from a network client system, such a PC 168 or STB 124. In some embodiments, the user operates an Internet website of the provider using PC 168 to initiate the order. In some embodiments, the order is initiated using a button 121 on remote control unit 120 or a graphical user element on display 126. In certain embodiments, the order is initiated using a voice interface from an analog or Voice-over Internet Protocol (VoIP) phone (not shown), cellular telephone 169, or via STB 124. In other embodiments, an instant messaging environment on PC 168, cellular telephone 169, STB 124, or other personal wireless device (e.g., personal digital assistant (PDA), smart phone, mobile computer, etc.) is used to initiate the order.

Upon initiation of the order, recommendation engine 149 may become activated, or is invoked as a user application, and is used to provide recommendations to other users, according to the methods described herein. The recommendation engine 149 may interact with the user according to the method used to initiate the order, and is configured to enable different user interface options, selections, navigation menus, etc. for the respective interface. In some embodiments, recommendation engine 149 uses a text interface in an instant messaging environment to provide a user interface. In certain embodiments, recommendation engine 149 uses a voice menu, providing audio instructions and interpreting speech or dial-tone inputs by the user as program commands. In some embodiments, the user can mix or select the type of interface option desired. For example, in a voice menu, the user may choose to have a confirmation message sent to a specific address, such as an instant messaging or an email account. In other embodiments, the user can select a call-back option on a voice phone from an Internet website to process the recommendation.

In some embodiments, recommendation engine 149 executes on, or communicates with, application server 142, which can be used to provide user applications in numerous environments, as discussed above. In some embodiments, recommendation engine 149 receives information from the user for processing the recommendation request. In certain embodiments, recommendation engine 149 accesses subscriber system store 148 via application server 142 to retrieve user information relevant to the recommendation request. For example, recommendation engine 149 may query subscriber system store 148 to determine the account standing of a potential receiving user of the recommendation. Recommendation engine 149 may also query contact lists 151 to retrieve a list of users for receiving the recommendation. In some embodiments, recommendation engine 149 determines presence information for potential receiving user(s) of the recommendation. The above examples of receiving user information are not limiting and various other types of receiving user information, alone or in combination, may be retrieved and used for processing the recommendation.

As shown in the embodiment disclosed by FIG. 1, recommendation engine 149 accesses OSS/BSS gateway 144, which in turn provides access to OSS/BSS server 164, as described above. Recommendation engine 149 also accesses contact lists 151, which as shown in FIG. 1 may be maintained and managed by application tier 104. In other embodiments, contact lists may be managed in a different manner in IPTV system 100, for example, in a database coupled to operations and management tier 108. Contact lists 151 may include a list of contact information for each user of IPTV system 100. In some embodiments, a user's contact list includes contact information for individuals known to the user, such as friends and family, but does not include the contact information for the user himself or herself. By centrally storing and managing the contact list, IPTV system 100 may provide access to a unified contact list to each user, regardless of how the user accesses the contact list, or accesses applications that invoke the contact list. Accordingly, recommendation engine 149 may provide functions for adding, deleting, or editing entries in a user's contact list, using any of the user interface options for accessing IPTV system 100, as discussed in detail above.

In some embodiments, recommendation engine 149, in response to collecting recommendation requests, determines whether the recommendation is allowed or prohibited by the receiving user. In some cases, a prohibited recommendation request, as defined by a second receiving user's filter settings, is deleted after sending by a first user, and is not received by a second receiving user. Other rules and algorithms for processing recommendations may be implemented by recommendation engine 149, as desired.

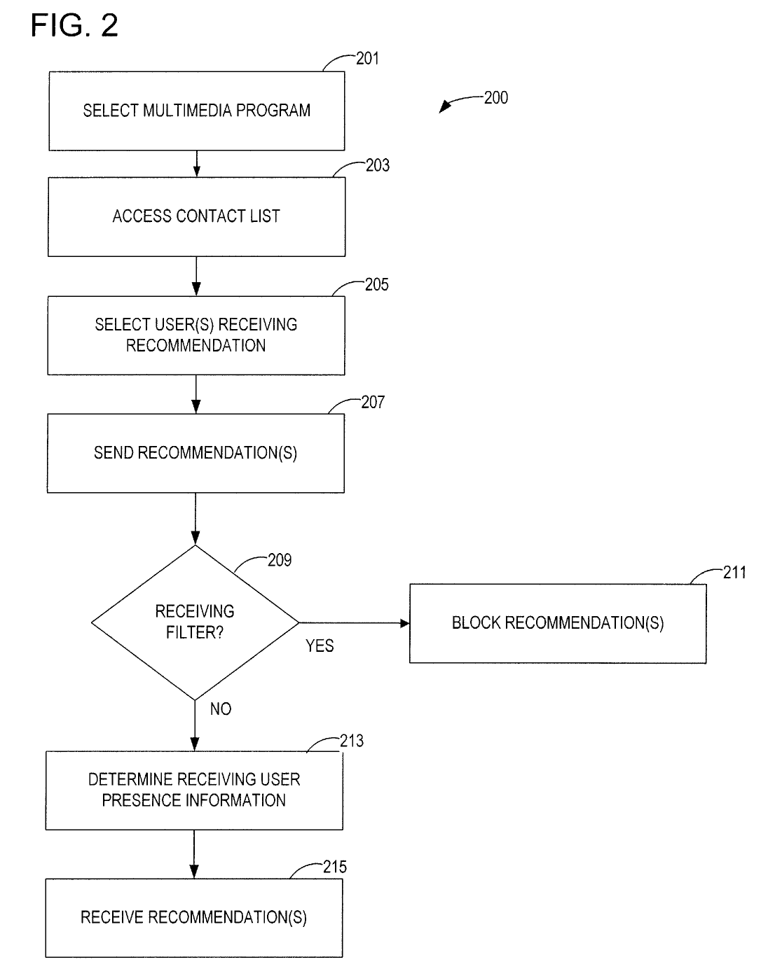

FIG. 2 illustrates in block diagram form a methodology 200 for processing recommendations. It is noted that individual operations described in methodology 200 may be optional or performed in a different sequence, depending on the specific embodiment. In some embodiments, the methodology 200 is performed by recommendation engine 149 of IPTV system 100. Although methodology 200 is described for a single multimedia program, in other embodiments, it will be understood that methodology 200 is repeated or concurrently executed for multiple or additional multimedia programs. For enhanced clarity of the exemplary description of methodology 200 presented below, a first user sending the recommendation shall be referred to in the feminine form, while a second user receiving the recommendation shall be referred to in the masculine form.

In operation 201, a first user selects a multimedia program via the provider network. The selection of the multimedia program by the first user may be for broadcasting, recording (for subsequent broadcasting), and/or for recommending to one or more additional users, including a second user. In one embodiment of operation 201, the first user selects an IPTV program, orders the IPTV program, and concurrently decides to recommend the IPTV program to the second user.

In operation 203, the first user accesses her individual contact list. In some embodiments, the contact list for the first user is centrally managed by the provider network, and may be made available to her in operation 203 for editing, display, or selection in text, graphical, audio, or other multimedia format. For example, her personal contact list may be stored with contact lists for a plurality of other users in contact lists 151, as mentioned above. In other embodiments, the contact list is not associated with the provider network, but is managed by the first user on her own external system. For example, the first user may use contact management software on her PC or mobile telephone. In still other embodiments, the contact list is a combination of central and local data stores, with optional communication and update algorithms for maintaining consistency. The first user's contact list represents the individuals to whom she may send recommendations for multimedia programs.

After accessing her contact list in operation 203, in operation 205 the first user selects one or more entries in the contact list, representing receiving users for the recommendation. In one embodiment, she selects at least the second user, who is also enabled to purchase multimedia content from the provider network. In another embodiment, the second user is not a customer of the provider network at the time he is selected for receiving the recommendation by the first user. In this case, the second user may be offered the opportunity to subscribe or sign up as a new customer of the provider network for receiving multimedia content. Depending on the implementation of the contact list, the selection of one or more receiving users may be from a list of names, symbols, nicknames, etc. in different embodiments.

In operation 207, the recommendations for the multimedia program selected in operation 201 are sent to the users selected in operation 205. As noted above, the recommendation may be sent in one or more of a variety of formats, such as email, instant message, function on a STB user interface, on an Internet website, as a voice message (automated or in person), or a hardcopy which is printed and mailed, among other formats. It is noted that in some embodiments, operation 207 may be performed after filter operation 209. It is further noted that sending the recommendation in operation 207 does not necessarily result in the recommendation being received by the intended recipient, as will be described below.

In operation 209, a receiving filter may be applied to the recommendations sent by the first user. In certain embodiments, each recipient may configure his own receiving filter, based on his own individual preferences. The receiving filters may be stored by the provider network, for example, by IPTV system 100. In one embodiment, the receiving filter is managed and maintained by recommendation engine 149, and may be included in contact lists 151. In other embodiments, the receiving filter is stored locally on the second user's hardware device, and he may have different filters for his different devices. For example, the second user may have a first receiving filter configured on a wireless communication device, and a second receiving filter, configured differently from his first receiving filter, on a PC. The receiving filter can be configured to allow or prohibit recommendations for multimedia content from reaching the second user. The filter criteria may include, the identity of the first user, a time period, the number of recommendations sent by the first user, an attribute of the multimedia content, or a combination thereof Other filter criteria may be implemented in other embodiments, as desired.

If the filter is applied to a given recommendation to the second user, then the result in operation 209 is YES, and execution continues to operation 211. In operation 211, the recommendation is blocked. In one embodiment, a blocked recommendation is never sent to the second user. In another embodiment, as depicted in FIG. 2, a sent recommendation is blocked from being received by the second user.

If the filter is not applied to a given recommendation to the second user, then the result in operation 209 is NO, and execution continues to operation 213. In operation 213, presence information is determined for the one or more recipients selected in operation 205. In one embodiment, the location of the second user is determined by the state of his cellular telephone from a wireless cellular phone network. In another embodiment, the location of the second user is determined by the state of his STB. The presence information determined in operation 213 may be used to decide the best method of sending the recommendation to the second user, in operation 215. In operation 215, the recommendation is received by the second user. As described previously, the recommendation may be received in one or more of a variety of formats, such as email, instant message, function on a STB user interface, on an Internet website, as a voice message (automated or in person), or a hardcopy which is printed and mailed, among other formats. In some embodiments, the second user can select the recommended program for ordering directly from the received recommendation.

In a further embodiment (not shown in FIG. 2), the receiving filter can be used to qualify the recommendation based on the identity of the first user. For example, the second user can designate the first user as trusted, and can configure the filter to automatically order, record, or download the recommended multimedia content upon receiving a recommendation from her. Other automated actions using the receiving filter are also contemplated.

Additional aspects of the methods described herein may include messaging functionality using IPTV system 100 for communicating between the first and second user. For example, if the second user rejects or prohibits the recommendation from the first user, a corresponding notification may be provided to her. In other instances, the first and second user may be unable to communicate directly, and recommendation engine 149 may be configured to relay messages between them using IPTV system 100.

Still additional aspects of the methods described herein may include expanding the scope of the recommendations to cover products and/or services offered for sale by third parties using IPTV system 100. For example, recommendations based on advertising or on a purchase may be processed using IPTV system 100.

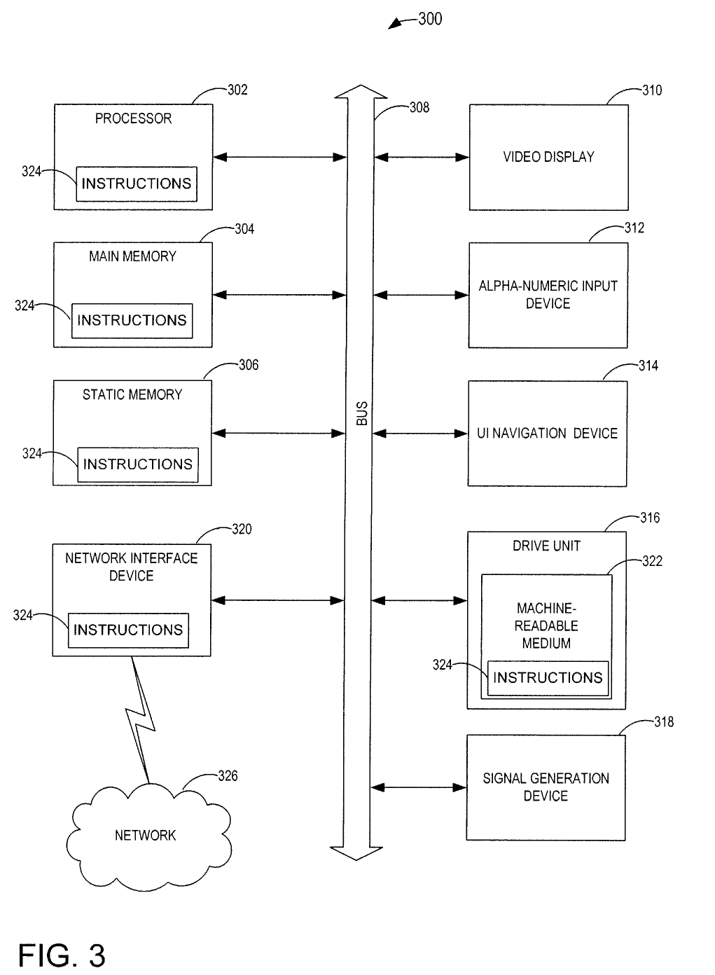

FIG. 3 is a diagrammatic representation of a machine in the example form of a computer system 300 within which a set of instructions for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a DVR, a PC, a tablet PC, an STB, a cable box, a satellite box, an EPG box, a PDA, a cellular telephone, a smart phone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with one other via a bus 308. The main memory 304 and/or the static memory 306 may be used to store the channel history data. The computer system 300 may further include a video display unit 310 on which to display broadcast or other programs, for example. The computer system 300 also includes an alphanumeric input device 312 (e.g., a keyboard or a remote control), a user interface (UI) navigation device 314 (e.g., a remote control, or a mouse), a disk drive unit 316, a signal generation device 318 (e.g., a speaker) and a network interface device 320. The input device 312 and/or the navigation device 314 (e.g., the remote control) may include a processor (not shown), and a memory (not shown). The disk drive unit 316 includes a machine-readable medium 322 on which is stored one or more sets of instructions and data structures (e.g., instructions 324) embodying or utilized by any one or more of the methodologies or functions described herein (e.g., the software to implement recommendation engine 149 and contact lists 151). The instructions 324 may also reside, completely or at least partially, within the main memory 304 and/or within the processor 302 during execution thereof by the computer system 300.

The instructions 324 may further be transmitted or received over a network 326 (e.g., a television cable provider) via the network interface device 320 utilizing any one of a number of well-known transfer protocols (e.g., broadcast transmissions, HTTP). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, they are not intended to limit the subject matter of the claims to the particular forms set forth. On the contrary, they are intended to cover such alternatives, modifications and equivalents as may be included within the spirit and scope of the subject matter as defined by the appended claims.

What is claimed is:

1. A method for recommending a multimedia program by a first user of a provider network, the method comprising:
enabling the first user to select a second user of the provider network from a contact list, wherein the contact list is associated with the first user; and
sending an indication to the second user that the multimedia program has been recommended by the first user.

2. The method of claim 1, wherein presence information for the second user is used for sending the indication to the second user, and wherein said presence information is indicative of whether the second user is then using the provider network.

3. The method of claim 1, further comprising:
enabling the second user to allow recommendations for multimedia programs to be received from the first user; and
receiving the indication from the first user that the multimedia program has been recommended.

4. The method of claim 1, further comprising:
enabling the second user to prohibit recommendations for multimedia programs to be received from the first user; and
rejecting the indication from the first user that the multimedia program has been recommended.

5. The method of claim 1,
wherein the multimedia program is delivered on a pay-per-view basis.

6. The method of claim 1,
wherein the multimedia program is delivered on an on-demand basis.

7. The method of claim 1, wherein the multimedia program includes an audio broadcast.

8. The method of claim 1, wherein the multimedia program includes a video broadcast.

9. The method of claim 2,
wherein the contact list is accessible by the first user via the provider network; and
wherein the contact list includes the presence information for the second user.

10. The method of claim 1,
wherein the first user uses a set-top box enabled for bidirectional-communication with the provider network to select the multimedia program and select the second user.

11. The method of claim 1,
wherein the first user uses a wireless communications device to select the multimedia program and select the second user.

12. A computer program product stored on one or more computer readable media, for recommending a first multimedia program, and comprising computer executable instructions to:
enable the first user to select a first plurality of users of the provider network from a contact list associated with the first user; and
send an indication to the first plurality of users that the first multimedia program has been recommended by the first user.

13. The computer program product stored on a computer readable medium of claim 12, further comprising computer executable instructions to:
enable a second user to allow recommendations for multimedia programs to be received from the first user; and
receive the indication from the first user that the first multimedia program has been recommended to the second user.

14. The computer program product stored on a computer readable medium of claim 13, further comprising computer executable instructions to:
enable the second user to automatically record the first multimedia program on a digital video recorder.

15. The computer program product stored on a computer readable medium of claim 13, further comprising computer executable instructions to:
receive the indication from the first user that the first multimedia program has been recommended to the first plurality of users.

16. The computer program product stored on a computer readable medium of claim 13, further comprising computer executable instructions to:
enable the second user to purchase the first multimedia program for viewing over the provider network.

17. The computer program product stored on a computer readable medium of claim 12, further comprising computer executable instructions to:
enable a third user to prohibit recommendations for multimedia programs to be received from the first user, wherein the third user is included in the first plurality of users; and
reject the indication from the first user that the first multimedia program has been recommended to the third user.

18. The computer program product stored on a computer readable medium of claim 12, further comprising computer executable instructions to:
enable a fourth user to specify conditions indicative of when recommendations for multimedia programs are allowed to be received from the first user, wherein the fourth user is included in the first plurality of users.

19. The computer program product stored on a computer readable medium of claim 12, further comprising computer executable instructions to:
enable a fifth user to specify how many recommendations for multimedia programs are allowed to be received from the first user, wherein the fifth user is included in the first plurality of users.

20. The computer program product stored on a computer readable medium of claim 12, further comprising computer executable instructions to:
enable the first user to select with a wireless communication device a second multimedia program for viewing over the provider network;
enable the first user to select a second plurality of users of the provider network from the contact list, wherein the second plurality of users is different from the first plurality of users, wherein the second plurality of users does not include the first user; and
send an indication to the second plurality of users that the second multimedia program has been recommended by the first user.

21. A system for recommending a multimedia program, comprising:
a processor; and
a memory including program instructions, executable by the processor, to:
enable a first user of provider network to purchase the multimedia program for viewing over the provider network;
enable the first user to select a first plurality of users of the provider network from a contact list, wherein the contact list is accessible by the first user via the provider network; and
send an indication over the provider network to the first plurality of users that the multimedia program has been recommended by the first user, wherein the contact list includes presence information indicative of whether any of the first plurality of users is available for communication over the provider network.

22. The system of claim 21, wherein presence information for the first plurality of users is used for sending the indication to the first plurality of users.

23. The system of claim 22, wherein the instructions to send the indication over the provider network to the first plurality of users include instructions to send the indication using a text message.
